(19) United States
(12) Patent Application Publication
(10) Pub. No.: US 2026/0358975 A1
(43) Pub. Date: Nov. 12, 2026

(54) APPARATUS WITH DATA-RETENTION BASED USAGE OF CORRECTIVE READ OPERATIONS AND METHODS FOR OPERATING THE SAME

(71) Applicant: Micron Technology, Inc., Boise, ID (US)

(72) Inventors: Yu-Chung Lien, San Jose, CA (US); Sampath K. Ratnam, San Jose, CA (US); Shantilal Doru, San Diego, CA (US); Zhenming Zhou, San Jose, CA (US)

(21) Appl. No.: 19/656,554

(22) Filed: Apr. 23, 2026

Related U.S. Application Data
(60) Provisional application No. 63/802,492, filed on May 8, 2025.

(51) Int. Cl. G06F 3/06

(52) U.S. Cl. CPC G06F 3/0655; G06F 3/0604; G06F 3/0679

(57) ABSTRACT

Methods, apparatuses and systems related to performing a corrective read during an initial portion of a read operation are described. The apparatus can increase the voltage on a targeted wordline and compute a bin assignment for the memory cells of the targeted wordline. The apparatus can perform a read on an adjacent wordline according to the computed bin assignment of the targeted wordline.

### CROSS-REFERENCE TO RELATED APPLICATIONS

The present application claims priority to U.S. Provisional Patent Application No. 63/802,492, filed May 8, 2025, the disclosure of which is incorporated herein by reference in its entirety.

### TECHNICAL FIELD

The disclosed embodiments relate to devices, and, in particular, to semiconductor memory devices with data-retention based usage of corrective read operations and methods for operating the same.

### BACKGROUND

Memory systems can employ memory devices to store and access information. The memory devices can include volatile memory devices, non-volatile memory devices (e.g., flash memory employing “NAND” technology or logic gates, “NOR” technology or logic gates, or a combination thereof), or a combination device. The memory devices utilize electrical energy, along with corresponding threshold levels or processing/reading voltage levels, to store and access data. However, the performance or characteristics of the memory devices change or degrade over time or usage. The change in performance or characteristics conflicts with accurately reading stored data from the memory devices, leading to errors and other performance issues.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of a computing system in accordance with an embodiment of the present technology.

FIG. 2 is an illustration of charge loss in a memory cell at the beginning of a read operation in accordance with an embodiment of the present technology.

FIG. 3 is an illustration of voltage ramping during a digital count fail byte operation in accordance with an embodiment of the present technology.

FIG. 4 is an illustration of corrective read operation waveforms in accordance with an embodiment of the present technology.

FIG. 5 is an illustration of a lookup table in accordance with an embodiment of the present technology.

FIG. 6 is a flow diagram illustrating an example method of operating an apparatus in accordance with an embodiment of the present technology.

FIG. 7 is a schematic view of a system that includes an apparatus in accordance with an embodiment of the present technology.

### DETAILED DESCRIPTION

As described in greater detail below, the technology disclosed herein relates to an apparatus, such as memory systems, systems with memory devices, related methods, etc., for performing corrective read operations. A computing system, such as an enterprise computer, a server, a distributed computing system, or the like, may include a memory device configured to store and read data from a memory cell that experienced charge loss.

Charge loss in memory cells is a significant issue that can lead to data corruption and reduced reliability. This problem is particularly evident during read operations, where the electrical charge stored in a target wordline can migrate to adjacent wordlines due to degradation mechanisms, such as leakage to a channel. This migration of the electrical charge results in a charge loss in the target wordline. This charge loss can lead to incorrect data being read from the memory cells, thereby compromising the integrity of the stored information.

To address the issue of charge loss in memory cells, embodiments of the present technology implement several corrective measures. One such measure is a charge loss detection operation (e.g., digital count fail byte (DCFB) operation), which detects charge loss during the voltage ramp-up stage of a read operation. By incrementally ramping up the voltage (e.g., at a slower rate than other conventional read operations), the apparatus can detect an initial response indicating charge loss. The apparatus can assign the affected/read memory cells to a charge-loss bucket classifier (CBC) bin or other such charge loss category or grouping according to the detected amount of charge loss. Each CBC bin is associated with a read level offset to correct for the charge loss. Additionally, the present technology includes performing corrective read operations on adjacent wordlines to further adjust the read level voltage and correct for the charge loss. For example, prior to reading a selected wordline, the apparatus detects the data pattern for an adjacent wordline. Based on the detected data pattern, the apparatus determines to execute a corrective read to adjust the read level for the target wordline. These combined techniques ensure that the memory system can accurately read data despite the presence of charge loss, thereby enhancing the reliability and integrity of the stored information.

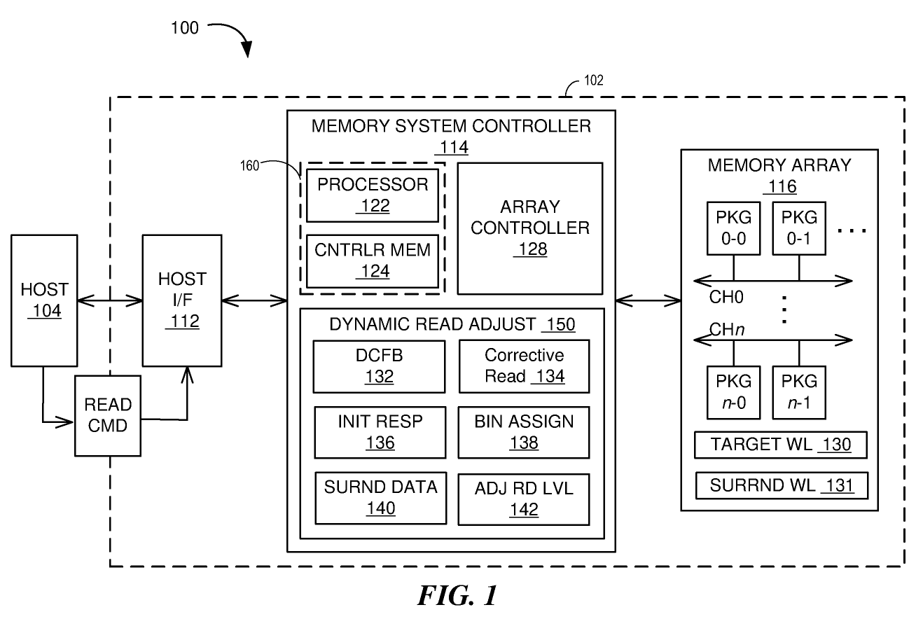

FIG. 1 is a block diagram of a computing system 100 in accordance with an embodiment of the present technology. The computing system 100 can include a personal computing device/system, an enterprise system, a mobile device, a server system, a database system, a distributed computing system, or the like. The computing system 100 can include a memory system 102 coupled to a host device 104. The host device 104 can include one or more processors that can write data to and/or read data from the memory system 102, such as during execution of an operating system. For example, the host device 104 can include an upstream central processing unit (CPU).

The memory system 102 can include circuitry configured to store data (via, e.g., write operations) and provide access to stored data (via, e.g., read operations). For example, the memory system 102 can include a persistent or non-volatile data storage system, such as a NAND-based Flash drive system, a Solid-State Drive (SSD) system, a SD card, or the like. In some embodiments, the memory system 102 can include a host interface 112 (e.g., buffers, transmitters, receivers, and/or the like) configured to facilitate communications with the host device 104. For example, the Host interface 112 can be configured to support one or more host interconnect schemes, such as Universal Serial Bus (USB), Peripheral Component Interconnect (PCI), Serial AT Attachment (SATA), or the like. The host interface 112 can receive commands, addresses, data (e.g., write data), and/or other information from the host device 104. The host interface 112 can also send data (e.g., read data) and/or other information to the host device 104.

The memory system 102 can further include a memory system controller 114 and a memory array 116. The memory array 116 can include memory cells that are configured to store a unit of information. The memory system controller 114 can be configured to control the overall operation of the memory system 102, including the operations of the memory array 116.

In some embodiments, the memory array 116 can include a set of NAND Flash devices or packages. Each of the packages can include a set of memory cells that each store data in a charge storage structure. The memory cells can include, for example, floating gate, charge trap, phase change, ferroelectric, magnetoresitive, and/or other suitable storage elements configured to store data persistently or semi-persistently. The memory cells can be one-transistor memory cells that can be programmed to a target state to represent information. For instance, electric charge can be placed on, or removed from, the charge storage structure (e.g., the charge trap or the floating gate) of the memory cell to program the cell to a particular data state. The stored charge on the charge storage structure of the memory cell can indicate a threshold voltage (Vt) of the cell. For example, a single level cell (SLC) can be programmed to a targeted one of two different data states, which can be represented by the binary units 1 or 0. Also, some flash memory cells can be programmed to a targeted one of more than two data states. Multilevel cells (MLCs) may be programmed to any one of four data states (e.g., represented by the binary 00, 01, 10, 11) to store two bits of data. Similarly, triple level cells (TLCs) may be programmed to one of eight (i.e., 2³) data states to store three bits of data, and quad level cells (QLCs) may be programmed to one of 16 (i.e., 2⁴) data states to store four bits of data.

Such memory cells may be arranged in rows (e.g., each corresponding to a wordline) and columns (e.g., each corresponding to a bit line). The arrangements can further correspond to different groupings for the memory cells. For example, each wordline can correspond to one or more memory pages. Also, the memory array 116 can include memory blocks that each include a set of memory pages. In operation, the data can be written or otherwise programmed (e.g., erased) with regards to the various memory regions of the memory array 116, such as by writing to groups of pages and/or memory blocks. In NAND-based memory, a write operation often includes programming the memory cells in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

While the memory array 116 is described with respect to the memory cells, it is understood that the memory array 116 can include other components (not shown). For example, the memory array 116 can also include other circuit components, such as multiplexers, decoders, buffers, read/write drivers, address registers, data out/data in registers, etc., for accessing and/or programming (e.g., writing) the data and for other functionalities.

As described above, the memory system controller 114 can be configured to control the operations of the memory array 116. The memory system controller 114 can include a processor 122, such as a microcontroller, special purpose logic circuitry (e.g., a field programmable gate array (FPGA), an application specific integrated circuit (ASIC), etc.), or other suitable processor. The processor 122 can execute instructions encoded in hardware, firmware, and/or software (e.g., instructions stored in controller embedded memory 124 to execute various processes, logic flows, and routines for controlling operation of the memory system 102 and/or the memory array 116.

Further, the memory system controller 114 can further include an array controller 128 that controls or oversees detailed or targeted aspects of operating the memory array 116. For example, the array controller 128 can provide a communication interface between the processor 122 and the memory array 116 (e.g., the components therein). The array controller 128 can function as a multiplexer/demultiplexer, such as for handling transport of data along serial connection to flash devices in the memory array 116.

In controlling the operations of the memory system 102, the memory system controller 114 (via, e.g., the processor 122 and the embedded memory 124) can implement a Flash Translation Layer (FTL) 160. The FTL 160 can include a set of functions or operations that provide translations for the memory array 116 (e.g., the Flash devices therein). For example, the FTL 160 can include the logical-physical address translation, such as by providing the mapping between virtual or logical addresses used by the operating system to the corresponding physical addresses that identify the Flash device and the location therein (e.g., the layer, the page, the block, the row, the column, etc.). Also, the FTL 160 can include a garbage collection function that extracts useful data from partially filed units (e.g., memory blocks) and combines them to a smaller set of memory units. The FTL 160 can include other functions, such as wear-leveling, bad block management, concurrency (e.g., handling concurrent events), page allocation, error correction code (e.g., error recovery), or the like.

The memory system 102 can include a dynamic read adjustment mechanism 150 configured to adjust read level voltage according to real-time conditions of the memory array 116. In some embodiments, the dynamic read adjustment mechanism 150 can detect a real-time charge loss measure (e.g., a representation of an amount of lost charge since they were last stored or refreshed at the corresponding memory cell) based on directly accessing the target memory cell. Additionally, the dynamic read adjustment mechanism 150 can further detect the charge loss and/or any negative effects on the charge retention capability/status based on accessing wordlines adjacent to the selected wordline. The memory system 102 can use the resulting charge loss detections to dynamically adjust the read level voltage used to read the data in the target memory cell.

As an illustrative example, in response to receiving a read command for reading stored data from the memory cells of the memory array 116, the memory system controller 114 can perform a DCFB 132 operation. The memory system controller 114 can compute a bin assignment 138 for the memory cells of the memory array 116 based on (1) incrementally increasing the voltage on a targeted wordline 130 and (2) detecting an initial response 136 during the incremental increase. The computed bin assignment 138 can correspond to a bin in a CBC binset lookup table.

The bin values of the CBC binset lookup table can be organized based on thresholds used to trigger a corrective read 134. For example, bin values below a first threshold indicate a charge loss that requires a one bit corrective read (1bCR) operation, bin values below a second threshold indicate a charge loss that requires a two bit corrective read (2bCR) operation, and bin values below a third threshold indicate a charge loss that requires a four bit corrective read (4bCR) operation. Thus, the more data degradation that is detected in a memory cell, the more complex of a corrective read can be implemented to lower the bit error rate. The memory system controller 114 can perform the corrective read 134 operation (e.g., 1bCR, 2bCR, 4bCR, etc.) on the at least one adjacent wordline 131 to the targeted wordline 130 according to the computed bin assignment. The corrective read 134 can provide surrounding data 140 (e.g., a measure or a derivative of the corresponding charge levels) stored in memory cells coupled to the surrounding wordline 131, and the memory system 104 (via, e.g., the memory system controller 114) can compute an adjusted read level 142 according to the bin assignment 138 and the surrounding data 140. The adjusted read level 142 can correspond to trim adjustments made from an initial read level voltage. Additional details regarding performing corrective read operations are provided below.

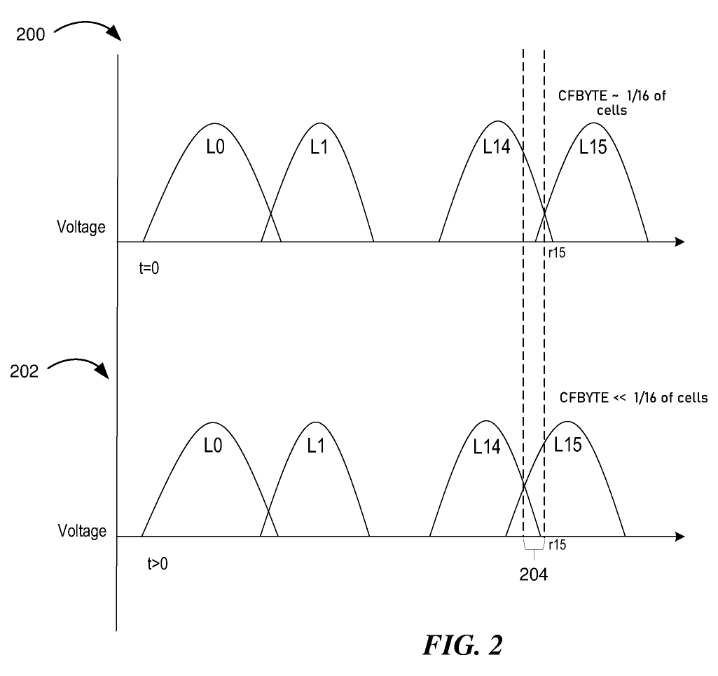

FIG. 2 is an illustration of charge loss in a memory cell at the beginning of a read operation in accordance with an embodiment of the present technology. Due to degradation, such as leakage to a channel, the electrical charge stored in memory cells coupled to a target wordline (e.g., the target wordline 130 of FIG. 1) can migrate to an adjacent wordline(s) (e.g., the surrounding wordline(s) 131 of FIG. 1). The migration of the electrical charge to the adjacent wordline(s) results in a charge loss in the target wordline. Waveform 200 illustrates an initial storage state when the memory cells are first programed, and waveform 202 illustrates a degraded storage state at a later time as a result of the charge loss in a wordline of a memory apparatus. For example, an offset 204 in the waveform 202 illustrates the charge loss at time “t>0” between wordlines L14 and L15 when compared to the waveform 200 at time “t=0.” Prior to reading the target wordline, an apparatus (e.g., the computing system 100, the memory system 102, and/or the memory system controller 114, illustrated in FIG. 1) can perform a corrective read on the adjacent wordline and use the result thereof to correct for the charge loss experienced by the target wordline. A corrective read operation can include an apparatus performing a read operation of an adjacent wordline(s) and a read operation of the target wordline. Additional details regarding the corrective read are provided below.

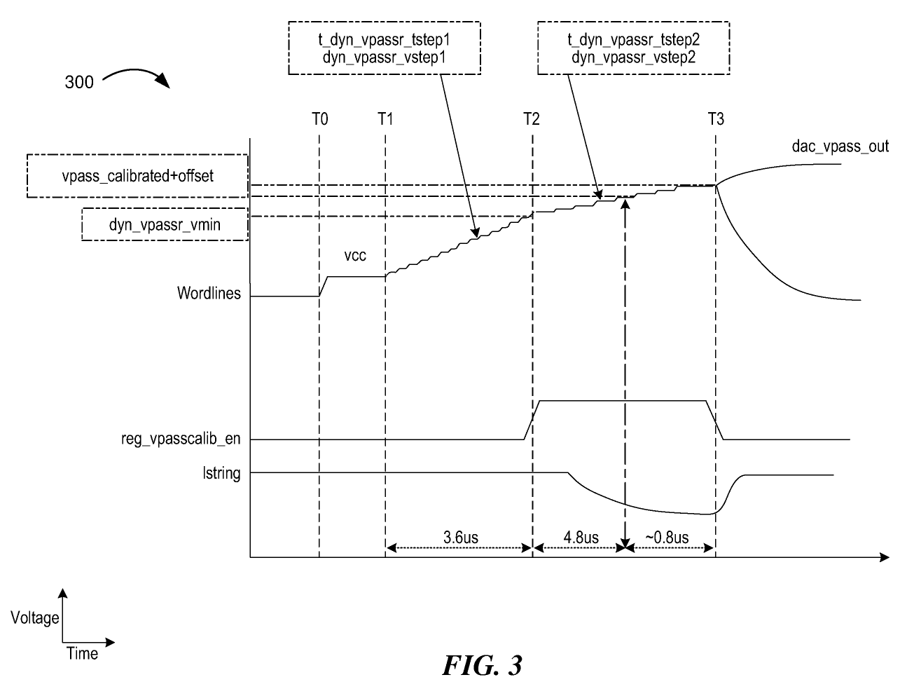

FIG. 3 is an illustration of voltage ramping during a DCFB (the DCFB 132 of FIG. 1) operation in accordance with an embodiment of the present technology. To detect charge loss at a target wordline, an apparatus (e.g., the computing system 100, the memory system 102, and/or the memory system controller 114, illustrated in FIG. 1) can implement the DCFB operation during a read operation. During the DCFB operation, the voltage is increased to the target voltage (e.g., Vpassr in graph 300) incrementally and at a slower rate than a conventional read operation. The voltage ramp up is illustrated between time “T1” and time “T2” in graph 300.

As the voltage is increased to the target voltage on the target wordline, the apparatus can detect an initial response (e.g., the initial response 136 of FIG. 1). For example, the apparatus performs read sensing in the memory cells coupled to the target wordline. The apparatus can compute a bin assignment for the memory cells coupled to the target line based on the detected initial response indicating a charge loss during the voltage increase. In other words, by slowly and incrementally increasing the word line voltage, the apparatus can determine the voltage level that causes the current flow associated with the read event. The voltage level causing the read event would have been affected (e.g., in comparison to t=0 of FIG. 2) due to the charge loss. Accordingly, the apparatus can characterize the charge loss according to the voltage level causing the read event. The apparatus can assign the memory cell(s) to a CBC bin of a CBC binset lookup table according to the charge loss characterization. Each CBC bin in the CBC binset lookup table can be assigned a read level offset to correct for an associated charge loss.

Additionally or alternatively, the apparatus can perform a parallel auto read calibration (pARC) operation to fine tune the voltage read level at the read time of a read operation. A pARC operation includes performing voltage leveling at incremental voltage amounts below and above the target voltage value to determine the optimal voltage read level. For example, the apparatus can divide the memory cells or a portion of the memory cells into a predetermined number of subgroupings and read each of the subgroupings using a unique fine adjustment level. The apparatus can calculate an error rate for each of the unique fine adjustment levels and select a unique fine adjustment level from the subgroupings that has the lowest error rate.

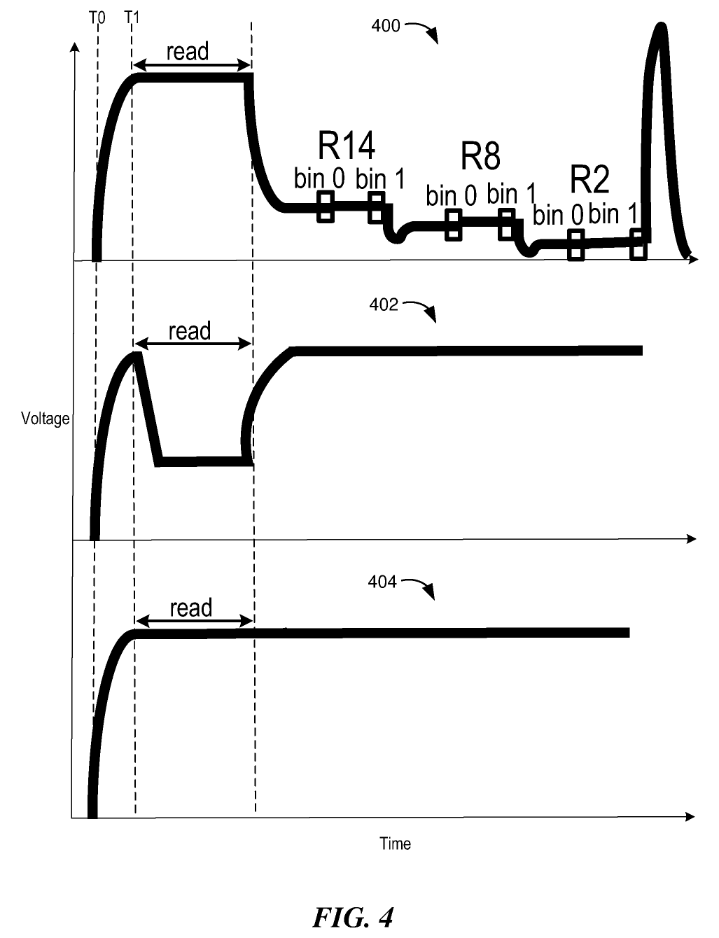

FIG. 4 is an illustration of corrective read operation waveforms in accordance with an embodiment of the present technology. An apparatus (e.g., the computing system 100, the memory system 102, and/or the memory system controller 114, illustrated in FIG. 1) can perform read sensing in the memory cells coupled to a wordline as the voltage is increased to the target voltage value between time “T0” and time “T1”. Based on the results of the read sensing, the apparatus can determine the number of cells that have experienced charge loss.

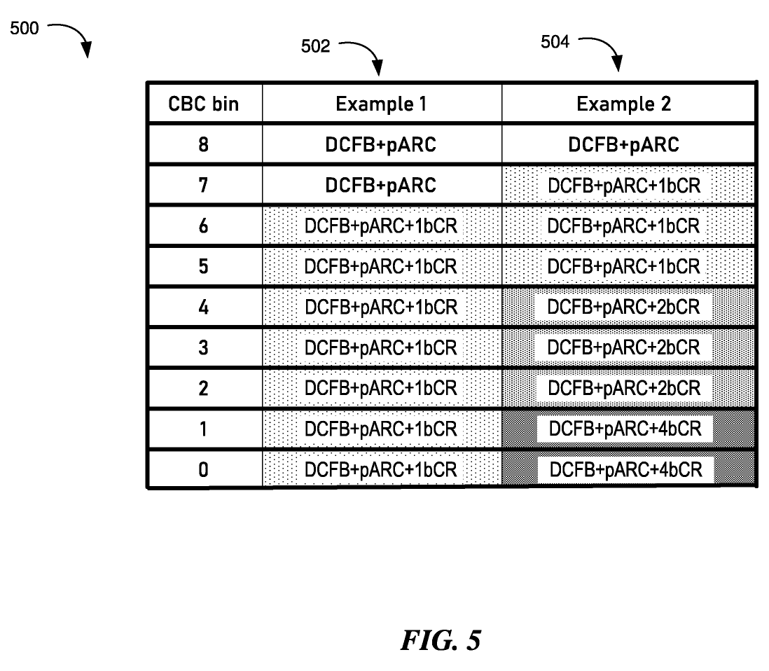

The apparatus can assign the memory cell(s) a CBC bin value of a CBC binset lookup table based on the amount of charge loss. Each CBC bin, such as bin 0 and bin 1 in waveform 400, can be assigned a read level offset. The apparatus can determine to perform a corrective read (e.g., 1bCR, 2bCR, 4bCR, etc.) on an adjacent wordline(s) to the target wordline based on the CBC bin value of the lookup table assigned to the target wordline. For example, lookup table 500 of FIG. 5 (described in further detail below) illustrates CBC bin values corresponding to DCFB, pARC, 1bCR, 2bCR, and 4bCR operations. The corrective read operation adjusts the read level voltage, such as R14, R8, and R2, to correct for the charge loss in the target wordline.

During a 1bCR operation, the apparatus reads data from a single adjacent wordline (e.g., WLₙ₋₁ orWLₙ₊₁) that is physically adjacent to the target wordline (WLₙ). The 1bCR operation can produce data from the adjacent wordline corresponding to one of 2^m bit values (where m=1 for a 1bCR). The apparatus can utilize a 2-dimensional (2D) lookup table to determine a base set of adjustments to the read level from the adjacent wordline. For example, the apparatus adjusts the bit values of one of the two possible adjacent wordlines (e.g., WLₙ₋₁ orWLₙ₊₁). The 1bCR operation can produce a result from the read of the adjacent wordline.

During a 2bCR operation, the apparatus reads data from two adjacent wordlines (e.g., WLₙ₋₁ andWLₙ₊₁) that are physically adjacent to the target wordline (WLₙ). The 2bCR operation can produce data from the adjacent wordlines corresponding to one of 2^m bit values (where m=2 for a 2bCR). The 2^m bit values can be divided into 4 groups corresponding to the adjacent wordlines. The apparatus can utilize the lookup table to determine a base set of adjustments to the read level for both adjacent wordlines. For example, the apparatus adjusts the bit values of the two adjacent wordlines (e.g., WLₙ₋₁ andWLₙ₊₁). The two adjacent wordlines can be on opposite sides of the target wordline. The 2bCR operation can produce a result (e.g., each including 2^m bit values) from the read of each adjacent wordline. For example, a first adjustment value when the surrounding data is among a first group of values from the2^m bit values and (2) a second adjustment value when the surrounding data is among a remainder of values in the 2^m bit values.

During a 4bCR operation, the apparatus reads data from two adjacent wordlines but increases the number of cross sections in adjusting the bit values compared to 2bCR. In other words, the 1bCR and 2bCR operations can examine one aspect of the adjacent wordlines, such as accessing one portion (e.g., first or second half) of memory cells connected to the wordlines, and 4bCR operation can examine additional aspects (e.g., two or more out of four groupings) of the adjacent wordlines. The 4bCR operation can produce data from the adjacent wordlines corresponding to one of 2^m bit values (where m=4 for a 4bCR). The apparatus can utilize the lookup table to determine a base set of adjustments to the read level for the adjacent wordlines. The lookup table can include 2^j adjustment values (where j corresponds to a number of groupings for the 2^m possible bit values). A 4bCR allows for multiple groupings of adjustments to be organized by bin assignment thresholds (e.g., cut lines). For example, the thresholds correspond to an increase in detected charge loss. Column 504 of table 500 of FIG. 5 illustrates that threshold to initiate a 1bCR is a bin assignment of 7, the threshold to initiate a 2bCR is a bin assignment of 4, and the threshold to initiate a 4bCR is bin assignment of 1.

Waveforms 402 and 404 illustrate example read operation waveforms for adjacent wordlines (e.g., WLₙ₋₁ andWLₙ₊₁) during a corrective read operation. In a first example, for TLCs, the read voltage for the adjacent wordline WLₙ₊₁ follows waveform 402 and the read voltage for the adjacent wordline WLₙ₋₁ follows the waveform 404. In a second example, for QLCs, the read voltage for both adjacent wordlines WLₙ₊₁ and WLₙ₋₁ follow the waveform 402.

FIG. 5 is an illustration of a lookup table 500 in accordance with an embodiment of the present technology. Upon determining the CBC bin assignment of a target wordline, an apparatus (e.g., the computing system 100, the memory system 102, and/or the memory system controller 114, illustrated in FIG. 1) can determine whether the CBC bin value corresponds to executing a corrective read operation. Column 502 illustrates one example embodiment in which a bin assignment of 7 or 8 results in the apparatus performing DCFB and pARC operations. For the illustrated embodiment, bin 8 can correspond to no charge loss or the smallest amount of charge loss and be associated with the initial read level voltage (e.g., without any adjustments). As charge loss increases (e.g., duration since charge storage/refresh), the apparatus can adjust the bin assignment for the corresponding memory cell to a lower bin number that is associated with a higher read voltage level adjustment. Memory cells having the lowest bin assignment (e.g., bin 0) can be refreshed, and the bin assignment can be reset to the highest value.

For the corresponding bin assignment pattern, the apparatus can implement the corrective read operation when the charge loss reaches a threshold level. In some embodiments, the apparatus can be configured to implement the corrective read when the bin assignment reaches a threshold level. For the example embodiment illustrated in the column 502 of FIG. 5, the triggering threshold to perform a 1bCR can be a bin assignment of 6. For example, a bin assignment of 0 through 6 results in the apparatus performing DCFB, pARC, and 1bCR operations.

Column 504 illustrates a second example embodiment that implements different levels of the corrective read according to the severity of the charge loss. For example, bin assignment of 8 results in the apparatus performing DCFB and pARC operations. The triggering threshold to perform a 1bCR is a bin assignment of 7. When the target cells are categorized with a bin assignment of 5 through 7, the apparatus can perform DCFB, pARC, and 1bCR operations. The triggering threshold to perform a 2bCR can be a bin assignment of 4. For example, a bin assignment of 4 through 2 results in the apparatus performing DCFB, pARC, and 2bCR operations. The triggering threshold to perform a 4bCR is a bin assignment of 1. For example, a bin assignment of 0 through 1 results in the apparatus performing DCFB, pARC, and 4bCR operations. In some embodiments, the triggering threshold can be two or more bins advanced from an initial bin (e.g., bin 8) that corresponds to an initially written charge levels for the stored data.

Although the lookup table 500 illustrates 9 CBC bins, it is understood that the lookup table can include any number of total bins. Additionally, although the triggering thresholds in FIG. 5 are illustrated as bin 6 in column 502 and bins 7, 4, and 1 in column 504, it is understood that the triggering thresholds can be at any CBC bin value.

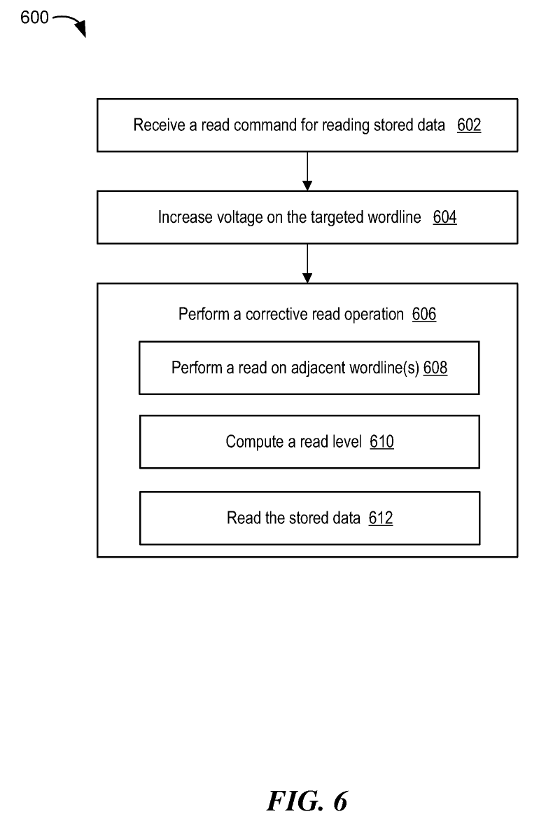

FIG. 6 is a flow diagram illustrating an example method 600 of operating an apparatus (e.g., the computing system 100, the memory system 102, and/or the memory system controller 114, illustrated in FIG. 1) in accordance with an embodiment of the present technology. The apparatus can include a memory array with rewritable memory cells (e.g., NAND memory cells) configured to store charges representative of stored data. The memory cells can be coupled to wordlines configured to provide access control to the memory cells by activating the memory cells.

At block 602, the apparatus can receive, via an interface circuit coupled to the memory array, a read command for reading the stored data from the memory cells. The read command can correspond to a single-plane read, a multiplane read, or an independent wordline read.

At block 604, the apparatus, via a memory controller coupled to the memory array, can initially increase a voltage on a targeted wordline. Initially increasing the voltage can include computing a bin assignment (e.g., from n number of total bins) for the memory cells based on (1) incrementally increasing the voltage on the wordline and (2) detecting an initial response during the incremental increase. The computed bin assignment corresponds to a bin in a CBC binset lookup table. Each CBC bin in the CBC binset lookup table can be assigned a read level offset to correct for different charge loss levels of a memory cell. The bin values of the CBC binset lookup table can be organized based on triggering threshold. For example, bin values below a first threshold indicate a charge loss that requires a 1bCR operation, bin values below a second threshold indicate a charge loss that requires a 2bCR operation, and bin values below a third threshold indicate a charge loss that requires a 4bCR operation. Thus, the more data degradation that is detected in a memory cell, the more complex of a corrective read required to lower the bit error rate.

At block 606, the apparatus can perform a corrective read operation (e.g., 1bCR, 2bCR, 4bCR, etc.). The corrective read operation can include a read operation on adjacent wordline(s) and a read on the target wordline. At block 608, the apparatus can perform a read on at least one adjacent wordline to the targeted wordline according to the bin assignment. At block 610, the apparatus can compute a read level based on one or more surrounding data resulting from the corrective read. The read level computation can include the CBC bin result from step 604 and a data pattern from the read operation. The apparatus can compute the read level based on adjusting an initial read level according to the surrounding data stored in the at least one adjacent wordline. At block 612, the apparatus can read the stored data from the memory cells using the computed read level.

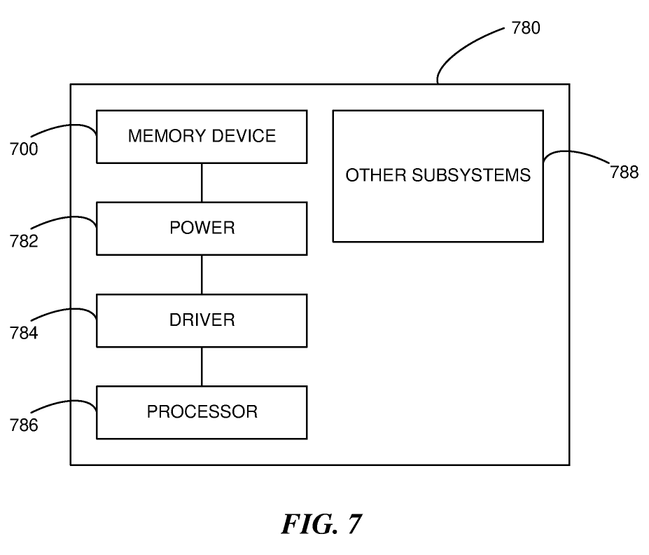

FIG. 7 is a schematic view of a system that includes an apparatus in accordance with embodiments of the present technology. Any one of the foregoing apparatuses (e.g., memory devices) described above with reference to FIGS. 2-6 can be incorporated into any of a myriad of larger and/or more complex systems, a representative example of which is system 780 shown schematically in FIG. 7. The system 780 can include a memory device 700, a power source 782, a driver 784, a processor 786, and/or other subsystems or components 788. The memory device 700 can include features generally similar to those of the apparatus described above with reference to one or more of the FIGS, and can therefore include various features for performing a direct read request from a host device. The resulting system 780 can perform any of a wide variety of functions, such as memory storage, data processing, and/or other suitable functions. Accordingly, representative systems 780 can include, without limitation, hand-held devices (e.g., mobile phones, tablets, digital readers, and digital audio players), computers, vehicles, appliances and other products. Components of the system 780 may be housed in a single unit or distributed over multiple, interconnected units (e.g., through a communications network). The components of the system 780 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the illustrated embodiments above, the apparatuses have been described in the context of NAND Flash devices. Apparatuses configured in accordance with other embodiments of the present technology, however, can include other types of suitable storage media in addition to or in lieu of NAND Flash devices, such as, devices incorporating NOR-based non-volatile storage media (e.g., NAND flash, ReRAM, PCM, etc.), magnetic storage media, phase-change storage media, ferroelectric storage media, dynamic random access memory (DRAM) devices, etc.

The term "processing" as used herein includes manipulating signals and data, such as writing or programming, reading, erasing, refreshing, adjusting or changing values, calculating results, executing instructions, assembling, transferring, and/or manipulating data structures. The term data structure includes information arranged as bits, words or code-words, blocks, files, input data, system-generated data, such as calculated or generated data, and program data. Further, the term "dynamic" as used herein describes processes, functions, actions or implementation occurring during operation, usage, or deployment of a corresponding device, system or embodiment, and after or while running manufacturer's or third-party firmware. The dynamically occurring processes, functions, actions or implementations can occur after or subsequent to design, manufacture, and initial testing, setup or configuration.

The above embodiments are described in sufficient detail to enable those skilled in the art to make and use the embodiments. A person skilled in the relevant art, however, will understand that the technology may have additional embodiments and that the technology may be practiced without several of the details of the embodiments described above with reference to one or more of the FIGS. described above.

We claim:

1. A memory device, comprising:
a memory array including rewritable memory cells configured to store charges representative of stored data, wherein the memory cells are coupled to a targeted wordline configured to provide access control thereto;
an interface circuit coupled to the memory array and configured to receive a read command for reading the stored data from the memory cells; and
a memory controller operably coupled to the memory array and configured to:
initially increase a voltage on the targeted wordline in response to the read command, wherein initially increasing the voltage includes computing a bin assignment for the memory cells based on (1) incrementally increasing the voltage on the targeted wordline and (2) detecting an initial response during the incremental increase;
perform a read on at least one adjacent wordline according to the bin assignment;
compute a read level based on one or more surrounding data resulting from the read, wherein the read level is computed based on adjusting an initial read level according to the one or more surrounding data stored in the at least one adjacent wordline; and
read the stored data from the memory cells using the computed read level.

2. The memory device of claim 1, wherein the at least one adjacent wordline is physically adjacent to and located on at least one predetermined side relative to the targeted wordline.

3. The memory device of claim 2, wherein the read for the at least one adjacent wordline is performed when the bin assignment for the memory cells exceeds a triggering threshold.

4. The memory device of claim 3, wherein:
the memory controller is configured to compute the bin assignment from n number of total bins; and
the read for the at least one adjacent wordline is performed when the bin assignment is between the triggering threshold and up to nth bin.

5. The memory device of claim 3, wherein the triggering threshold is two or more bins advanced from an initial bin that corresponds to an initially written charge level for the stored data.

6. The memory device of claim 3, wherein:
the read is configured to produce the one or more surrounding data corresponding to one of 2^m bit values; and
the read level is adjusted based on determining an adjustment according to a lookup table that provides at least (1) a first adjustment value when the one or more surrounding data is among a first group of values from the 2^m bit values, and (2) a second adjustment value when the one or more surrounding data is among a remainder of values in the 2^m bit values.

7. The memory device of claim 2, wherein:
the at least one adjacent wordline is a first adjacent wordline on a first side of the targeted wordline; and
the read is performed using (1) the first adjacent wordline to produce a first result and (2) a second adjacent wordline to produce a second result,
wherein the second adjacent wordline is adjacent to the targeted wordline and on a second side that is opposite the first side,
wherein the first result and the second result each include one of 2^m bit values,
wherein the one or more surrounding data include the first result and the second result.

8. The memory device of claim 7, wherein the read level is adjusted based on determining an adjustment according to a 2-dimensional lookup table having a first dimension corresponding to the first result and a second dimension corresponding to the second result, wherein the 2-dimensional lookup table includes 2^j adjustment values where j corresponds to a number of groupings for the 2^m bit values.

9. The memory device of claim 8, wherein:
the first result and the second result are produced using the 2-dimensional lookup table when the bin assignment exceeds a second threshold that is beyond a first threshold and represents a worse charge loss than the first threshold,
wherein the first threshold represents using the first adjacent wordline without the second adjacent wordline for the read.

10. The memory device of claim 8, wherein j is 2 or greater.

11. The memory device of claim 8, wherein:
j is 3 or greater;
the 2-dimensional lookup table is configured to provide a subset of adjustments within the 2^j adjustment values, wherein the subset includes 2^i adjustments where i represents a different set of groupings for the 2^m bit values, wherein i is less than j;
the first result and the second result are produced using the 2-dimensional lookup table and the 2^j possible adjustments when the bin assignment exceeds a third threshold,
wherein the third threshold is beyond a second threshold and represents a worse charge loss than the second threshold, the second threshold for triggering the use of the i number of groupings and the subset of 2^i possible adjustments; and
wherein the second threshold is beyond a first threshold and represents a worse charge loss than the first threshold, the read utilizing using the first adjacent wordline without the second adjacent wordline for the read if the bin assignment is between the first threshold and the second threshold.

12. The memory device of claim 1, wherein the read level is computed based on:
determining the initial read level representative of an unadjusted or trimmed read level voltage;
determining a first adjustment according to the bin assignment;
determining a second adjustment based on (1) dividing the memory cells or a portion thereof into a predetermined number of subgroupings, (2) reading each of the subgroupings using a unique fine adjustment level, (3) calculating an error rate for each of the unique fine adjustment level, and (4) selecting one of the unique fine adjustment levels having a lowest error rate as the second adjustment according to a parallel auto read calibration mechanism; and
determining a third adjustment based on the surrounding data stored in the at least one adjacent wordline; and
adjusting the initial read level according to the first adjustment, the second adjustment, and the third adjustment.

13. The memory device of claim 1, wherein the read command corresponds to a single-plane read, a multiplane read, or an independent wordline read.

14. The memory device of claim 1, wherein the memory cells are NAND memory cells.

15. A memory controller, comprising:
at least one processor;
embedded memory coupled to the at least one processor and storing instructions for execution by the at least one processor, the instructions comprising:
receiving a read command for reading stored data from memory cells of the embedded memory;
initially increasing a voltage on a targeted wordline in response to the read command, wherein initially increasing the voltage includes computing a bin assignment for the memory cells based on (1) incrementally increasing the voltage on the targeted wordline and (2) detecting an initial response during the incremental increase;
performing a read on at least one adjacent wordline according to the bin assignment;
computing a read level based on one or more surrounding data resulting from the read, wherein the read level is computed based on adjusting an initial read level according to the one or more surrounding data stored in the at least one adjacent wordline; and
reading the stored data from the memory cells using the computed read level.

16. The memory controller of claim 15, wherein:
the at least one adjacent wordline is physically adjacent to and located on a predetermined side relative to the targeted wordline; and
the read for the at least one adjacent wordline is performed when the bin assignment for the memory cells exceeds a triggering threshold.

17. The memory controller of claim 16, wherein the instructions further include:
computing the bin assignment from n number of total bins,
wherein the read for the at least one adjacent wordline is performed when the bin assignment is between the triggering threshold and up to nth bin,
wherein the triggering threshold is two or more bins advanced from an initial bin that corresponds to an initially written charge level for the stored data.

18. A method comprising:
receiving a read command for reading stored data from memory cells of a memory array;
initially increasing a voltage on a targeted wordline in response to the read command, wherein initially increasing the voltage includes computing a bin assignment for the memory cells based on (1) incrementally increasing the voltage on the targeted wordline and (2) detecting an initial response during the incremental increase;
performing a read on at least one adjacent wordline according to the bin assignment;
computing a read level based on one or more surrounding data resulting from the read, wherein the read level is computed based on adjusting an initial read level according to the one or more surrounding data stored in the at least one adjacent wordline; and
reading the stored data from the memory cells using the computed read level.

19. The method of claim 18, wherein:
the at least one adjacent wordline is physically adjacent to and located on a predetermined side relative to the targeted wordline; and
the read for the at least one adjacent wordline is performed when the bin assignment for the memory cells exceeds a triggering threshold.

20. The method of claim 19, further comprising:
computing the bin assignment from n number of total bins,
wherein the read for the at least one adjacent wordline is performed when the bin assignment is between the triggering threshold and up to nth bin,
wherein the triggering threshold is two or more bins advanced from an initial bin that corresponds to an initially written charge level for the stored data.
